(19) United States
(12) Patent Application Publication
(10) Pub. No.: US 2014/0081911 A1
(43) Pub. Date: Mar. 20, 2014

(54) OPTIMIZING AUTOMATIC DELETION OF BACKUP FILES

(71) Applicant: Prathamesh Deshpande, Santa Clara, CA (US)

(72) Inventor: Prathamesh Deshpande, Santa Clara, CA (US)

(73) Assignee: NetApp, Inc., Sunnyvale, CA (US)

(21) Appl. No.: 12/987,921

(22) Filed: Jan. 10, 2011

(51) Int. Cl. G06F 12/16; G06F 17/30

(52) U.S. Cl. 707/610; 707/E17.005

(57) ABSTRACT

Various methods and systems are described for reclaiming used data storage space in a data storage system. In one embodiment, a system is provided for reclaiming space in a non-volatile memory storing a backup file. Here, a memory-reclaiming module stores information about the backup file in the non-volatile memory and synchronizes the information in the non-volatile memory with a copy of the information in a volatile memory. A policy that governs a deletion of the backup file is accessed. The memory-reclaiming module also retrieves the copy of the information from the volatile memory and deletes the backup file based on the policy and the copy of the information.

### FIELD

The present disclosure relates generally to data backup, and more specifically, to optimizing automatic deletion of backup files.

### BACKGROUND

When a data storage object (e.g., a volume) of a data storage system approaches a maximum data storage capacity, the data storage system may seek to reclaim some used data storage space. One conventional method by which the data storage system may reclaim some of the used data storage space is by automatically deleting particular sub-level storage objects (e.g., backup files, such as files that are copies of other files). A policy may be created to govern the deletion of such backup files.

To delete backup files automatically without violating the policy, the data storage system may need to identify certain information about the backup files. Examples of such information may include whether particular ones of the backup files were created according to a pre-defined schedule or created in response to a manual intervention by a user of the data storage system. Various techniques for identifying this information may negatively impact the performance of the data storage system. For example, if a process executing on a node of the data storage system determines this information by querying a different process every time data storage space is running low, the handling of such queries may require significant resources of the data storage system. For example, handling such queries may require significant processor, memory, and network resources of the data storage system, especially when such queries are generated by multiple processes executing on multiple nodes of the data storage system. Additionally, if the information is not cached in a memory device to result in better performance than caching in a non-volatile memory device (e.g., a hard disk), the handling of such queries may take a relatively long time.

### SUMMARY

Embodiments of the present invention provide various techniques for optimizing the automatic deletion of backup files. As an example, when information about a backup file is received, such as information that specifies that the backup file was created by a backup schedule defined by the user of the data storage system, this information is stored in a non-volatile memory device of a node of the data storage system. The information in the non-volatile memory device is then synchronized with a copy of the information in a volatile memory device of the node. This synchronization may be performed upon a restoring of power to the volatile memory device or upon a propagation of this information from a different node of the data storage system. Thus, the copy of the information in the volatile memory is kept up to date in all the nodes within a cluster.

Later, when available data storage space on the data storage system is running low, one or more backup files are identified as potential targets for deletion. Additionally, a policy that governs the automatic deletion of the potential targets is accessed. Whether the policy applies to the potential targets may depend on information about the potential targets. In this case, the copy of the information about the backup files is retrieved from the volatile memory device. The potential targets are then deleted automatically based on the policy and the copy of the information. Therefore, a process executing on a node of the data storage system may quickly retrieve the information it needs to perform the automatic deletion in conformance with the policy. The process does not need to query a different process executing on the data storage system or access a non-volatile memory device. Thus, the automatic deletion of backup files may be performed quickly and efficiently in comparison to various conventional techniques.

### BRIEF DESCRIPTION OF DRAWINGS

The present disclosure is illustrated by way of example and not limitation in the figures of the accompanying drawings, in which like references indicate similar elements and in which:

FIG. 1 depicts a block diagram of a system of processing systems, consistent with one embodiment of the present invention;

FIG. 2 depicts a block diagram of hardware associated with a node of the data storage system of FIG. 1;

FIG. 3 depicts an architectural block diagram of example software modules that the node of FIG. 2 is configured to execute;

FIG. 4 depicts a flow diagram of a general overview of a method, in accordance with an embodiment, for reclaiming used data storage space on a data storage system;

FIG. 5 depicts a block diagram illustrating the storing of information about a backup file in a non-volatile memory device and the synchronizing of the information with a copy of the information about the backup file in a volatile memory device;

FIG. 6 depicts a flow diagram of a more detailed method, in accordance with an alternate embodiment, for reclaiming used data storage space on a data storage system;

FIG. 7 depicts a block diagram of an example data structure containing information about backup files; and

FIG. 8 depicts a block diagram of an example computer system on which methodologies described herein may be executed.

### DESCRIPTION OF EXAMPLE EMBODIMENTS

The description that follows includes illustrative systems, methods, techniques, instruction sequences, and computing machine program products that embody the present invention. In the following description, for purposes of explanation, numerous specific details are set forth in order to provide an understanding of various embodiments of the inventive subject matter. It will be evident, however, to one skilled in the art that embodiments of the inventive subject matter may be practiced without these specific details. In general, well-known instruction instances, protocols, structures and techniques have not been shown in detail.

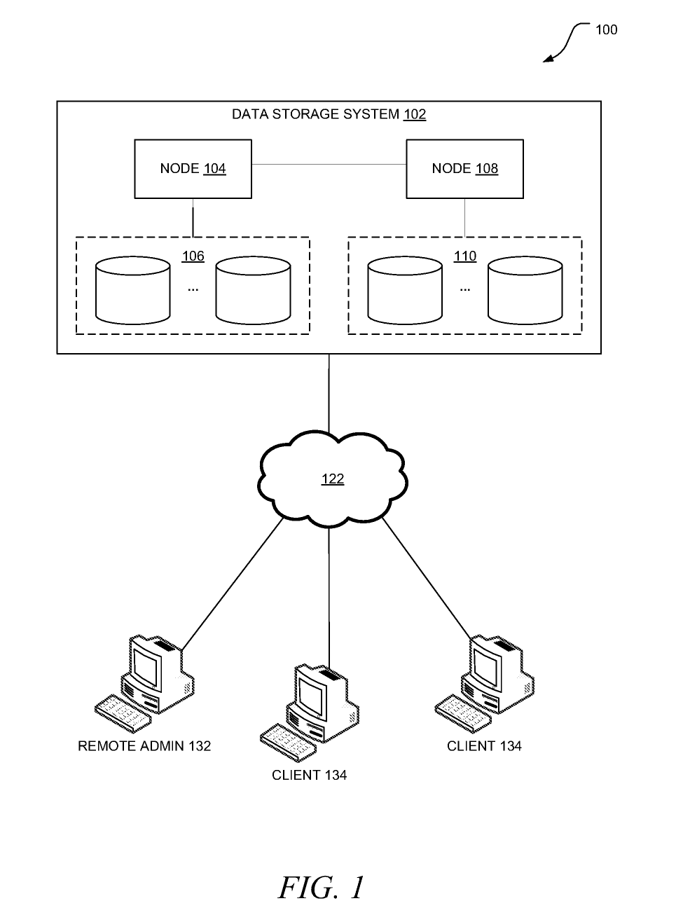

FIG. 1 depicts a block diagram of a system 100 of processing systems, consistent with one embodiment of the present invention. As depicted, the system 100 includes a data storage system 102 and various processing systems (e.g., clients 134 and remote administrative console 132) in communication with the data storage system 102 through network 122. For example, the network 122 may be a local area network (LAN) or wide area network (WAN). The data storage system 102 operates on behalf of the clients 134 to store and manage storage objects (e.g., blocks or files) in mass storage memories 106 and 110 (e.g., an array of hard disks). As used herein, a “file” is a collection of data constituting a storage object that has a name, called a filename. Examples of files include data files, text files, program files, directory files, and so on. Each of the clients 134 may be, for example, a conventional personal computer (PC), a workstation, a smart phone, or another processing system.

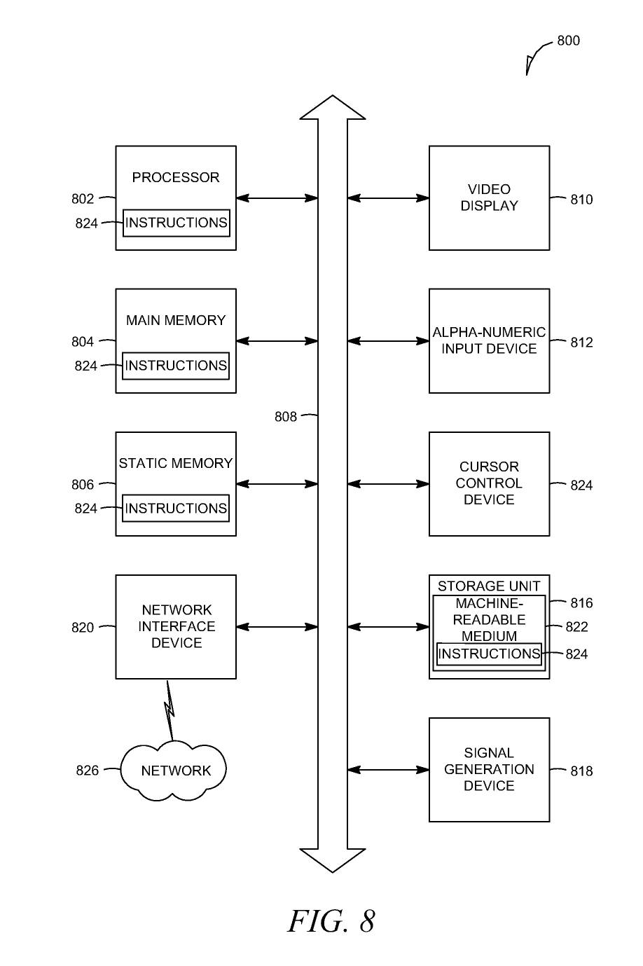

In this example, the data storage system 102 includes nodes 104 and 108 in communication with each other. As used herein, a “node” is a point in a computer network where a message can be created, received, or transmitted. A node may include one or more processors, storage controllers, memory, and network interfaces. A node may also be a “blade server,” which, as used herein, is a special-purpose computer having a modular design optimized to minimize the use of physical space and energy. An example of a node is the example computer system of FIG. 8. The nodes 104 and 108 also communicate with and manage the mass storage devices 106 and 110, respectively, and receive and respond to various read and write requests from the clients 134, directed to data stored in, or to be stored in, the data storage system 102. The mass storage devices 106 and 110 may be, for example, conventional magnetic disks, optical disks such as CD-ROM or DVD based storage, magneto-optical (MO) storage, or any other type of non-volatile storage devices suitable for storing large quantities of data. The mass storage devices may be organized into one or more volumes of Redundant Array of Inexpensive Disks (RAID). The data storage system 102 may be, for example, a file server, and more particularly, a network attached storage (NAS) appliance. Alternatively, the data storage system 102 may be a server that provides clients with access to information organized as data containers, such as individual data blocks, as may be the case in a storage area network (SAN). In yet another example, the data storage system 102 may be a device that provides clients with access to data at both the file level and the block level.

Also depicted in FIG. 1 is the remote administrative console 132 in communication with the data storage system 102. This configuration enables a network administrator or other users to perform management functions on the data storage system 102.

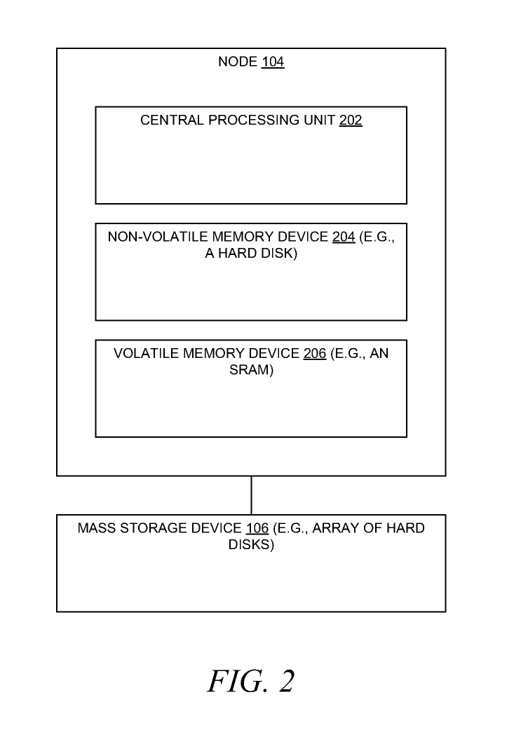

FIG. 2 depicts a block diagram of hardware associated with the node 104 of the data storage system 102 of FIG. 1. The hardware includes one or more central processing units (CPUs) 202, one or more non-volatile memory devices 204 (e.g., a hard disk), and one or more volatile memory devices 206 (e.g., an SRAM). The CPUs 202 may be, for example, one or more programmable general-purpose or special-purpose microprocessors or digital signal processors (DSPs), microcontrollers, application specific integrated circuits (ASICs), programmable logic devices (PLDs), or a combination of such devices. The memories 204 and 206 store, among other things, the operating system of the node 104.

As used herein, a “non-volatile memory” is a computer memory that retains its contents when it loses power. Examples of non-volatile memory may include read-only memory, flash memory, magnetic storage devices (e.g., a hard disk), and optical disks. As used herein, a “volatile memory” is a computer memory that loses its contents when it loses power. Examples of volatile memory may include random-access memory, SRAM, and DRAM.

The hardware also includes one or more mass storage devices 106. The mass storage devices 106 may be or include any machine-readable medium for storing large volumes of data in a non-volatile manner, such as one or more magnetic or optical based disks, or for storing one or more sets of data structures and instructions (e.g., software) embodying or utilized by any one or more of the methodologies or functions described herein.

It should be appreciated that in other embodiments, the node 104 may be associated with different hardware from that shown in FIG. 2. For example, in an alternate embodiment, the node 104 may not be associated with mass storage device 106.

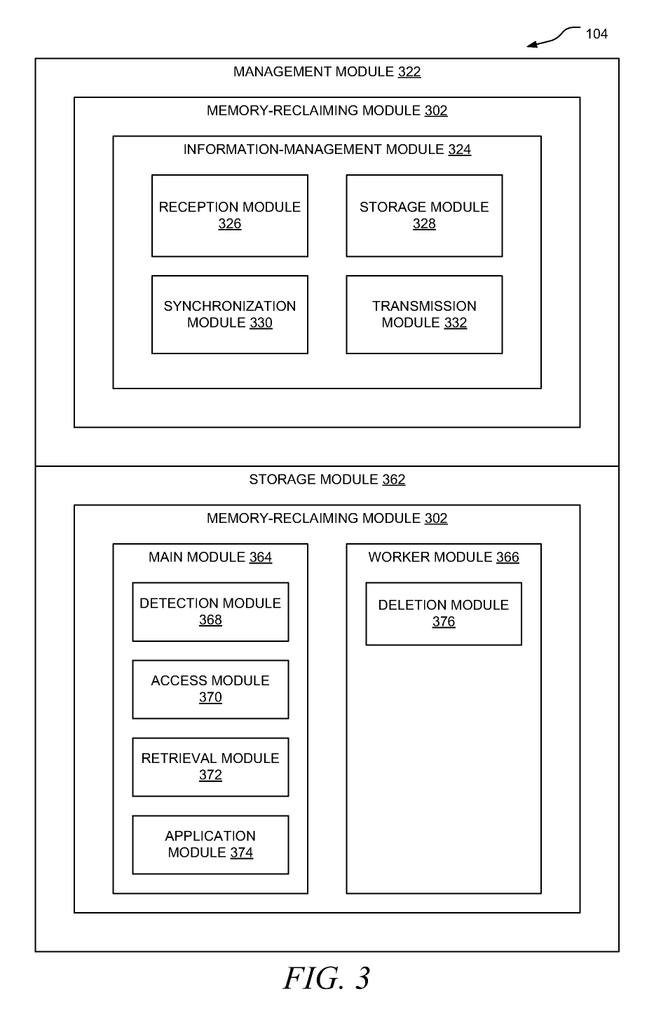

FIG. 3 depicts an architectural block diagram of example software modules that the node 104 is configured to execute, in accordance with an embodiment of the present invention. As depicted, the software modules include a management module 322 and a storage module 362. The management module 322 provides management functions for the data storage system 102. For example, the management module 322 may provide a command-line interface by which an administrator of the node 104 may access an operating system of the data storage system 102.

The storage module 362 provides functionality enabling the node to connect to one or more disks (e.g., mass storage device 106). As depicted, the software modules also include a memory-reclaiming module 302. The memory-reclaiming module 302 generally manages the reclaiming of used data storage space on the data storage system 102. In various embodiments, some modules of the memory-reclaiming module 302 may be included in the management module 322, whereas other modules of the memory-reclaiming module 302 may be included in the storage module 362.

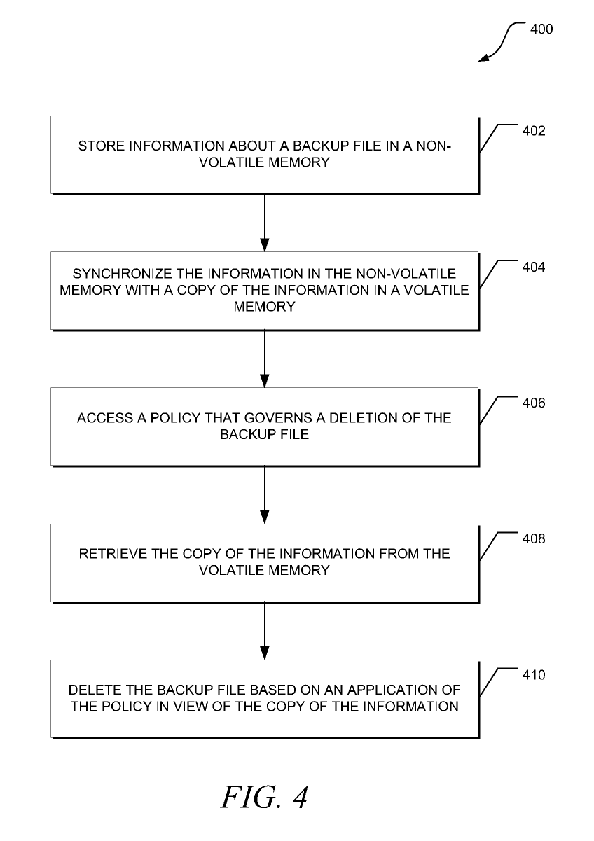

The memory-reclaiming module 302 includes an information-management module 324. The information management module 324 generally manages propagation of information about backup files across multiple nodes of the data storage system 102 and transfers of the information between modules of the system (e.g., between the management module 322 and the storage module 302). Examples of such information are discussed below with respect to FIG. 4. As used herein, a “backup file” is a file containing data that can be used to restore a different file if the different file is deleted. As described in more detail below, an example of a backup file is a snapshot. In various embodiments, the information-management module 324 includes a reception module 326, a storage module 328, a synchronization module 330, and a transmission module 332.

The reception module 326 is configured to receive the information about the backup files. For example, the reception module 326 may receive the information about the backup files from an administrator of the node 104 via the command-line interface provided by the management module 322.

The storage module 328 is configured to store the information in the non-volatile memory device 204 of the node 104 of the data storage system 102. Because the storage module 328 stores the information in the non-volatile memory device 204, the information is not lost when the node 104 loses power (e.g., during a crash of the node 104).

The synchronization module 330 is configured to synchronize the information stored in the non-volatile memory device 204 with a copy of the information stored in a volatile memory device (e.g., of the volatile memory device 206). Various synchronization techniques are described in detail below. For example, the synchronization module 330 may perform the synchronization upon a detection that power has been restored to the volatile memory device (e.g., upon a recovery of a crash of the node 104).

The transmission module 332 is configured to transmit information about backup files to one or more additional nodes (e.g., node 108) of the data storage system 102. Thus, the memory-reclaiming module 324 may replicate the information about backup files received at the node 104 across multiple nodes of the data storage system 102.

In this embodiment, the memory-reclaiming module 302 also includes a main module 364 and a worker module 366. The main module 364 and the worker module 366 may correspond to respective processes executing as part of a microkernel (e.g., an operating system) of the data storage system 102. The main module 364 generally handles determinations of whether to request the deletion of backup files. In various embodiments, the main module 364 includes a detection module 368, an access module 370, a retrieval module 372, and an application module 374.

The detection module 368 is configured to detect a satisfying of a pre-defined condition under which the main module 364 requests automatic deletion of backup files. For example, the detection module 368 may detect that the available data storage space in the node 104 is running low. Additional examples of the detecting of the pre-defined condition are described below with respect to FIG. 4.

The access module 370 is configured to access one or more policies governing the automatic deletion of backup files from the data storage system 102. As used herein, a “policy” is a set of rules specifying conditions under which backup files may be automatically deleted from a data storage system (e.g., data storage system 102). An example of a policy is a rule specifying that no backup files are to be automatically deleted from the data storage system. Additional examples of policies are described below with respect to FIG. 4. Same or different policies may be applied to each volume of the node 104. For example, a policy A may be applied to a volume 1 of the node 104, and policy A or B may be applied to volume 2 of the node 104. Additional and separate policies may be applied to volumes of node 102.

The access module 370 is also configured to access or generate lists of backup files stored on the data storage system 102. For example, the access module 370 may generate a list of backup files stored in a volume of the node 104 in which available data storage space is running low. Thus, the access module 370 is configured to generate a set of back up files that are potential targets for automatic deletion.

The retrieval module 372 is configured to retrieve a copy of the information about the backup files from the volatile memory device 206 of the node 104. As described above, the synchronization module 330 may have previously synchronized this information in the volatile memory with the information in the volatile memory, ensuring that the copy of the information is up-to-date when the retrieval module 372 retrieves it. Because the retrieval module 372 is able to retrieve a copy of the information from the volatile memory, the retrieval module 372 need not request the information using a different technique. For example, the retrieval module need not retrieve the information by transmitting data to and receiving data from the information-management module 324, such as by making an Application Program Interface (API) call to the information-management module 324. Furthermore, because the copy of the information resides in the volatile memory, which may be a higher-speed memory than the non-volatile memory in which the information resides, the retrieval module 372 may be able to retrieve the copy of the information in the volatile memory more quickly than it would be able to retrieve the information from the non-volatile memory. In this way, the retrieval module 372 may retrieve the copy of the information in a relatively quick and efficient manner.

The application module 374 is configured to request a deletion of a backup file. For example, the application module 374 may request the deletion based on the policy accessed by the access module 370, the list of backup files generated by the access module 370, and the copy of the information about the backup files retrieved from the volatile memory by the retrieval module 372.

The worker module 366 generally handles requests by the main module 368 pertaining to the deletion of backup files. The worker module 366 includes a deletion module 376, which is configured to delete backup files in response to requests by the main module 364 to perform the deletions.

It should be appreciated that in other embodiments, the software module of node 104 may include fewer, more, or different modules apart from those shown in FIG. 3. For example, in an example embodiment, the functionalities of the main module 364 and the worker module 366 may be combined.

FIG. 4 depicts a flow diagram of a general overview of a method 400, in accordance with an embodiment, for deleting a backup file based on a policy and a copy of information about the backup file. In an example embodiment, the method 400 may be implemented by the information-management module 324 depicted in FIG. 3 and employed in the system 100.

At operation 402, the storage module 328 stores information about a backup file in a non-volatile memory (e.g., in the non-volatile memory device 204). This information may have been received previously by the reception module 326. For example, the reception module 326 may have received the information from an administrator of the node 104 via a command-line interface provided by the management module 322. Or the reception module 326 may have received the information via a transmission from another node (e.g., the node 108) of the data storage system 102. Thus, the storage module 328 may store the information in response to the receiving of the information by the reception module 326.

The information may include information that can be used by the main module 364 (described below) to identify a particular backup file as a scheduled backup file or a user backup file. As used herein, a “scheduled backup file” is a backup file that is generated automatically by the system according to a pre-defined schedule. For example, a scheduled backup file may be a backup file that is created based on an elapsing of a time period since another backup file was created (e.g., after a month, week, day, hour, or minute). The pre-defined schedule may be based on a default schedule provided by a developer of the memory-reclaiming module 302. Additionally, the pre-defined schedule may be set by an administrator or other users of the data storage system 102 (e.g., via a command-line interface provided by the management module 322). Additionally, as used herein, a “user backup file” is a backup file that was created by a user independently of backup files created according to the pre-defined schedule. For example, a user backup file is a backup file that an administrator created manually (e.g., via the command-line interface of the management module 322).

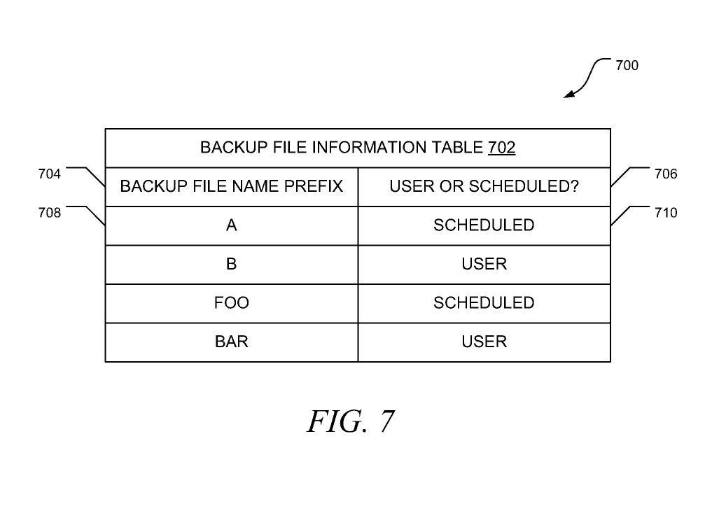

For example, the information about the backup file may include a mapping of particular backup file name prefixes to scheduled backup files or user backup files. That is, the information may specify that backup files having a file name prefix of “FOO” are scheduled backup files and backup files having a file name prefix of “BAR” are user backup files. As used herein, a “file name prefix” is the first n characters of a name of a file, where n is a number from 1 to the length of the name of the file. For example, the filename prefix of a file having a name of “FOO1” may be “F”, “FO”, “FOO”, or “FOO1”. An indicator such as a special character (e.g., an escape character or an underscore character) may be used to distinguish the filename prefix from the filename of a file. Alternatively, information about backup files may include specifications of filename prefixes, as described in more detail below with respect to FIG. 7.

Additionally or alternatively, the information about the backup files may include any suitable data that identifies one or more backup files as having a characteristic or attribute that affects whether a particular policy governs the deletion of the backup files. For example, such characteristics may include whether a particular backup file is locked, whether the deletion of a particular backup file would destroy backing data for a service of the data storage system 102, or whether the deletion of a particular backup file would disrupt data transfer on the data storage system 102. Examples of policies pertaining to backup files having various characteristics are discussed below with respect to a main module 364.

At operation 404, the synchronization module 330 synchronizes the information in the non-volatile memory with a copy of the information in a volatile memory (e.g., memory associated with volatile memory device 206). In one embodiment, the synchronization module 330 may detect differences between the information and the copy of the information. Then, based on the detection of the differences, the synchronization module 330 may call an API provided by the storage module 362 to add new portions of the information in the non-volatile memory to the copy of the information in the volatile memory. That is, the synchronization module 330 may treat any suitable portion of information that exists in the non-volatile memory but does not exist in the volatile memory as a new portion. The synchronization module 330 may also call an API provided by the storage module 362 to remove old portions of the information from the volatile memory. That is, the synchronization module 330 may treat any portion of information that exists in the volatile memory but does not exist in the non-volatile memory as an old portion. In an alternate embodiment, the synchronization module 330 may replace the copy of the information in the volatile memory with the information in the non-volatile memory. As described above, the synchronization module 330 may perform the synchronization based on the receiving of the information by the reception module 326 or a detection of power being restored to the volatile memory device 206. The end result is that the information in the non-volatile memory is the same as the copy of the information in the volatile memory.

At operation 406, the access module 370 accesses a policy that governs automatic deletion of the backup file. As described above, the policy may include one or more rules pertaining to the automatic deletion of the backup file. For example, the policy may include a rule that specifies that scheduled backup files are to be automatically deleted before user backup files. The policy may include a rule that specifies that a particular category of backup files may be automatically deleted from the data storage system 102. For example, the rule may specify that backup files that are not locked by a subsystem of the data storage system, that backup files that are locked and the deletion of which would destroy backing data, and that backup files are locked and the deletion of which would disrupt data transfer.

The policy may include a rule that specifies a data storage space condition under which backup files may be automatically deleted. For example, the rule may specify when data storage space on a volume is running low, when data storage space reserved for backup files is running low, or when data storage space reserved for user files is running low.

The policy may include a rule that specifies that a target amount of data storage space is to be made available. In this case, the main module 364 may request automatic deletion of backup files until the target amount of available data storage space has been reached. For example, if the rule specifies that the target amount of available data storage space for a volume is 20%, the main module 364 may request automatic deletion of backup files from the volume until the amount of available data storage space on the volume is 20%.

The policy may include a rule that specifies the order in which backup files should be automatically deleted. For example, the rule may specify that older backup files should be automatically deleted before newer backup files, or vice versa. Or the rule may specify that scheduled backup files should be deleted before user backup files. Or the rule may specify that backup files having a particular prefix should be automatically deleted after backup files having other prefixes are automatically deleted.

The policy may include a rule that specifies that backup files corresponding to files produced by a particular service of the data storage system 102 may be automatically deleted. For example, a rule may specify that backup files corresponding to files produced by a cloning service. As used herein, a “cloning service” may be a functional component of the data storage system that copies the contents (e.g., one or more files) of a first storage medium or a portion of the first storage medium to a file (e.g., an image file) or to a second storage medium or a portion of the second storage medium. Examples of cloning services include a logical unit number (LUN) clone service, a volume clone service, or a file clone service, such s a NetApp® storage system with FlexClone® technology. The policy may also include any combination of two or more rules.

The access module 370 may access the policy in response to a detection by the detection module 368 that a pre-defined condition has been met. One such pre-defined condition may be that the used data storage space on the data storage system 102 transgresses a threshold. For example, the pre-defined condition may be that the used data storage space of the data storage system 102 is 80% or higher of the data storage capacity of the data storage system 102. Another such pre-defined condition may be that the available data storage space on a volume of a node (e.g., node 104) of the data storage system 102 transgresses a threshold. One or more of the pre-defined conditions may be specified by an administrator of the data storage system 102. For example, the administrator may specify the pre-defined conditions using a command-line interface provided by the management module 322. Additionally, one or more of the pre-defined conditions may be default conditions specified by a developer of the memory-reclaiming module 302.

The access module 370 may access various used storage space thresholds to determine whether a particular data storage space is running low. For example, default used data storage thresholds may be established for volumes based on the data storage capacity of the volume. Thus, a used storage space threshold may be 85% for a volume having less than 20 GB of capacity, 90% for a volume having less than 100 GB of capacity, 92% for a volume having less than 500 GB of capacity, 95% for a volume have less than 1 TB of capacity, and 98% for a volume having greater than 1 TB of capacity. The various used storage space thresholds may be set by an administrator (e.g., via a command line interface provided by the management module 322).

At operation 408, the retrieval module 372 retrieves the copy of the information from the volatile memory. As described above, the synchronization module 330 may have previously synchronized this information in the volatile memory with the information in the volatile memory, ensuring that the copy of the information is up-to-date when the retrieval module 372 retrieves it. The copy of the information may enable the memory-reclaiming module 302 to identify a particular backup file as having a particular characteristic. Because the retrieval module 372 is able to retrieve a copy of the information from the volatile memory, the retrieval module 372 need not request the information using a different technique. For example, the retrieval module 372 may obtain the information without transmitting data to or receiving data from the information-management module 324 (e.g., via an API call) each time the retrieval module 372 needs the information. Thus, the retrieval module 372 may retrieve the copy of the information in a relatively efficient manner. Furthermore, because the copy of the information resides in the volatile memory, which may be a higher-speed memory than the non-volatile memory in which the information resides, the retrieval module 372 may be able to retrieve the copy of the information in the volatile memory more quickly than it would be able to retrieve the information from the non-volatile memory. Thus, the retrieval module 372 may retrieve the copy of the information in a relatively quick manner. The retrieval module 372 may retrieve the copy of the information in response to an accessing of a policy by the access module 370 or a generating of a list of potential deletion targets by the access module 370.

At operation 410, the deletion module 376 deletes the backup file. The deletion module 376 may perform the deletion based on a request from the application module 374. The application module 374 may request the deletion based on an application of the policy in view of the information about the backup file. For example, if the policy specifies that scheduled backup files are to be deleted before user backup files, and the copy of the information specifies that backup files having the first name prefix “FOO” are scheduled backup files, the application module 374 may request the deletion of the backup file if the prefix of the name of the backup file is “FOO”. The application module 374 may identify the backup file as a scheduled snapshot by iterating through a list of potential targets generated by the access module 370 and comparing the names of each of the potential targets with a backup file name prefix that identifies scheduled snapshots.

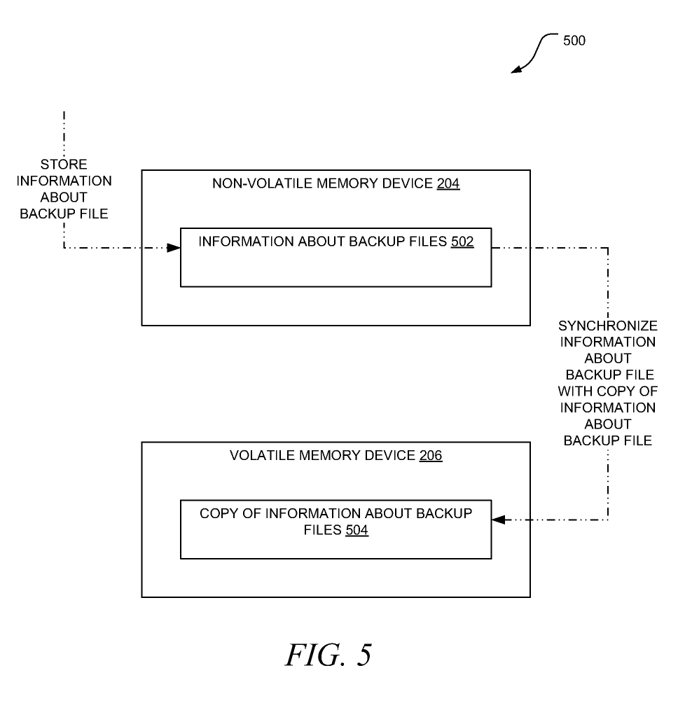

FIG. 5 depicts a block diagram illustrating the storing of information about the backup file in a non-volatile memory and the synchronizing of the information about the backup file with a copy of the information about the backup file in a volatile memory. The non-volatile memory device 204 stores information 502 about one or more backup files. As described above, the information 502 may include mappings of backup file name prefixes to backup file characteristics. Such mappings may, for example, enable the application module 374 to determine whether a particular backup file is a scheduled snapshot or user snapshot. The information 502 may be stored in the non-volatile memory device 204 by the storage module 328.

The volatile memory device 206 stores a copy 504 of the information 502 about the one or more backup files that is synchronized with the information 502 in the non-volatile memory device 204. The copy 504 of the information 502 may be synchronized with the information 502 about the one or more backup files by the synchronization module 330.

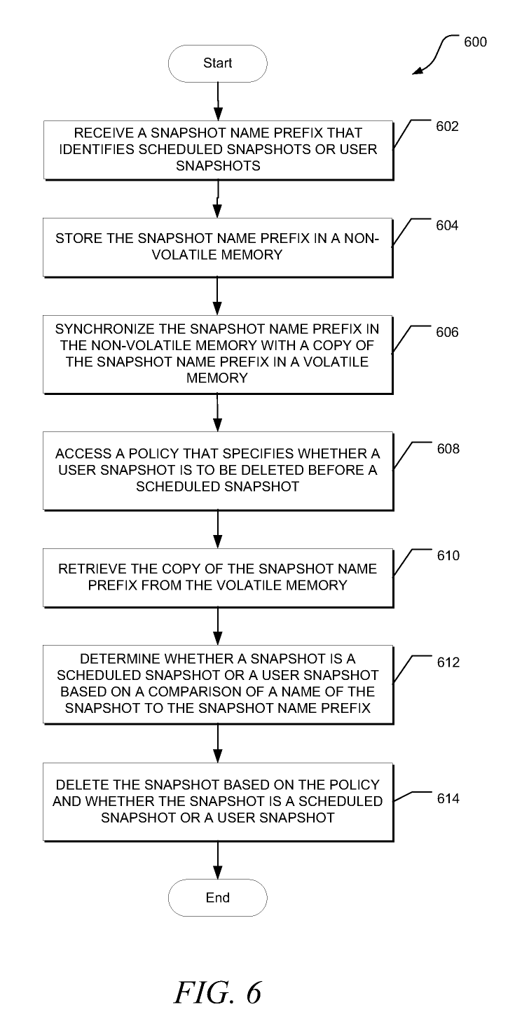

FIG. 6 depicts a flow diagram 600 of a more detailed method, in accordance with an alternate embodiment, for deleting a snapshot based on a policy and a copy of information about snapshots stored in a volatile memory. As used herein, a “snapshot” is a persistent consistency point (CP) image. A persistent consistency point image (PCPI) is a point-in-time representation of a data storage system, and more particularly, of an active data storage system, stored on a storage device (e.g., on disk) or in other persistent memory and having a name or other identifier that distinguishes it from other PCPIs taken at other points in time. A PCPI can also include other information (metadata) about the active data storage system at the particular point in time for which the image is taken. The terms “PCPI” and “snapshot” shall be used interchangeably throughout this patent without derogation of Network Appliance's trademark rights. A snapshot may be stored as one or more backup files on a data storage system (e.g., the data storage system 102).

In an example embodiment, the method 400 may be implemented by the information-management module 324 depicted in FIG. 3 and employed in the system 100. At operation 602, the reception module 326 receives a snapshot name prefix that identifies scheduled snapshots or user snapshots. For example, as discussed above, the reception module 326 may receive a mapping of the snapshot name prefix “FOO” to scheduled snapshots.

At operation 604, the storage module 328 stores the snapshot name prefix in a non-volatile memory. For example, the storage module 328 may store a mapping of the snapshot name prefix “FOO” to scheduled snapshots as an entry of a database table. The storage module 328 may store the mapping using a database computer language, such as Structured Query Language (SQL), included in a database associated with the memory-reclaiming module 322. The database table may be stored in the non-volatile memory associated with the management module 322.

At operation 606, the synchronization module 330 synchronizes the snapshot name prefix in the non-volatile memory with a copy of the snapshot name prefix in a volatile memory (e.g., an SRAM). For example, the synchronization module 330 may call an API of the storage module 362 to store the snapshot name prefix in a volatile memory associated with the storage module 362.

At operation 608, the access module 370 accesses a policy that specifies whether a user snapshot is to be deleted before a scheduled snapshot. For example, the policy may specify that a scheduled snapshot is to be deleted before a user snapshot.

At operation 610, the retrieval module 370 retrieves the copy of the snapshot name prefix from the volatile memory. Thus, the retrieval module 370 may be able to retrieve information about particular snapshots in a relatively quick and efficient manner. For example, the retrieval module 370 may retrieve the information without querying a separate module and without accessing a non-volatile memory device.

At operation 612, the application module 374 determines whether a snapshot is a scheduled snapshot or a user snapshot based on a comparison of a file name of the snapshot to the snapshot name prefix. The snapshot may be one of a set of snapshots that the access module 370 has identified as potential targets for deletion. For example, the snapshot may be one of a set of snapshots in a volume having a used storage space that is approaching the maximum storage capacity of the volume. In this case, the application module 374 may iterate over the set of snapshots, comparing each of the prefixes of the names (e.g., file names) of the snapshots in the list to the snapshot name prefix. The application module 374 may then identify each of the snapshots in the set as a scheduled snapshot or a user snapshot based on whether the snapshot name prefix matches a first part of the names of the snapshots. For example, if the snapshot name prefix identifies snapshots having the prefix “FOO” as scheduled snapshots, and the list includes snapshots having the names “FOO1”, “FOO2”, “BAR1” and “BAR2”, the application module 374 may identify the snapshots having the names “FOO1” and “FOO2” as scheduled snapshots based on a comparison of the first three characters of the names of each of the snapshots to the “FOO” prefix.

At operation 614, the deletion module 376 deletes the snapshot. The deletion module 376 may delete the snapshot upon receiving a request from the application module 374 to delete the snapshot. The application module 374 may request the deletion based on an application of a policy in view of the copy of the information. For example, the application module 374 may request the deletion based on an application of a policy that specifies that scheduled snapshots are to be deleted before user snapshots in view of a determination, based on the copy of the information, of whether the snapshot is a scheduled snapshot or a user snapshot.

FIG. 7 is a block diagram depicting a backup file information table 702. The backup file information table 702 may be a database table in which information about one or more backup files (e.g. information 502), such as backup files corresponding to one or more snapshots, is stored. The table may include a column 704 for backup file name prefixes and a column 706 for designations of whether particular backup file name prefixes correspond to user backup files or scheduled backup files. The database table may include one or more entries. For example, an entry may include a particular backup file name prefix 708 (e.g., “A”) and a designation 710 (e.g., “scheduled”) that identifies the particular backup files having the particular backup file name prefix 708 as scheduled backup files.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). As used herein, “cloud computing” may be a network-based (e.g., Internet-based) computing system in which shared resources, software, or information are provided to sub-level computing systems when requested. A sub-level computing system may embody a general- or special-purpose computer, a server, network of computers, or another data storage system for instance. In cloud computing, details may be abstracted from the sub-level computing system such that the sub-level computing system need not exercise control over infrastructure of the cloud. For example, cloud computing may take the form of a sub-level computing system accessing a remote, web-based application executing on a cloud from a web browser on the sub-level computing system computer and processing data using the web-based application as if it was executing within the sub-level computing system. At least some of the operations described herein may be performed by a group of computers (as examples of machines including processors) on a cloud. These operations may be accessible via a network (e.g., the network 120) and via one or more appropriate interfaces (e.g., APIs). For example, the modules of the management module 322 or the storage module 362 may be configured to execute on a cloud (e.g., to retrieve policies or information about backup files from a storage system of the cloud computing system). As another example, the node 104 or at least one of the central processing unit 202, the non-volatile memory device 204, the volatile memory device 206, or the mass storage device 106 may be derived from shared resources of the cloud.

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

FIG. 8 is a block diagram of machine in the example form of a computer system 800 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 includes a processor 802 (e.g., a central processing unit (CPU), a graphics processing unit (GPU) or both), a main memory 804 and a static memory 806, which communicate with each other via a bus 808. The computer system 800 may further include a video display unit 810 (e.g., a liquid crystal display (LCD) or a cathode ray tube (CRT)). The computer system 800 also includes an alphanumeric input device 812 (e.g., a keyboard), a user interface (UI) navigation (or cursor control) device 814 (e.g., a mouse), a disk drive unit 816, a signal generation device 818 (e.g., a speaker) and a network interface device 820.

### Machine-Readable Medium

The disk drive unit 816 includes a machine-readable medium 822 on which is stored one or more sets of instructions and data structures (e.g., software) 824 embodying or utilized by any one or more of the methodologies or functions described herein. The instructions 824 may also reside, completely or at least partially, within the main memory 804 and/or within the processor 802 during execution thereof by the computer system 800, the main memory 804 and the processor 802 also constituting machine-readable media. The instructions 824 may also reside, completely or at least partially, within the static memory 806. The central processing unit 202 may be an example of the processor 802.

While the machine-readable medium 822 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present embodiments, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and compact disc-read-only memory (CD-ROM) and digital versatile disc (or digital video disc) read-only memory (DVD-ROM) disks.

### Transmission Medium

The instructions 824 may further be transmitted or received over a communications network 826 using a transmission medium. The instructions 824 may be transmitted using the network interface device 820 and any one of a number of well-known transfer protocols (e.g., HTTP). Examples of communication networks include a LAN, a WAN, the Internet, mobile telephone networks, POTS networks, and wireless data networks (e.g., WiFi and WiMax networks). The term “transmission medium” shall be taken to include any intangible medium capable of storing, encoding or carrying instructions for execution by the machine, and includes digital or analog communications signals or other intangible media to facilitate communication of such software. The network 122 of FIG. 1 is an example of the network 826.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

1. A method of reclaiming space in a storage system, the method being performed by a processor and comprising:
receiving, at a second node of the storage system, a snapshot name prefix about a snapshot transmitted from a first node of the storage system, the snapshot name prefix being stored as an entry in a table that is stored in a non-volatile memory of the second node, the entry identifying the snapshot name prefix as corresponding to a scheduled snapshot or a user snapshot;
in response to the second node receiving the snapshot name prefix about the snapshot from the first node, synchronizing, at the second node, the snapshot name prefix in the non-volatile memory of the second node with a copy of the snapshot name prefix in a volatile memory of the second node, the volatile memory of the second node storing a plurality of copies of snapshot name prefixes corresponding to snapshots stored in the storage system;
accessing, at the second node, a policy that governs a deletion of snapshots stored in the storage system;
accessing the volatile memory of the second node rather than the non-volatile memory of the second node to determine one or more snapshots to delete based on the policy and the plurality of copies of snapshot name prefixes; and
deleting the one or more snapshots.

2. The method of claim 1, wherein the policy specifies that a scheduled snapshot is to be deleted before a user snapshot.

3. The method of claim 1, wherein the policy specifies that a user snapshot is to be deleted before a scheduled snapshot.

4-5. (canceled)

6. The method of claim 1, wherein the policy is accessed in response to detecting that a pre-defined condition has occurred.

7. The method of claim 1, wherein the snapshot name prefix corresponds to a first set of one or more characters of a name of the snapshot.

8. The method of claim 7, wherein an indicator character distinguishes the snapshot name prefix from a remainder of the name of the snapshot.

9. The method of claim 1, wherein the policy specifies an order in which snapshots is to be deleted based on age of the snapshots.

10. The method of claim 1, wherein the policy specifies that snapshots created by a cloning service are to be automatically deleted.

11-12. (canceled)

13. The method of claim 1, wherein the policy corresponds to the second node of the storage system and wherein the policy is accessed in response to detecting that a used data storage space on a volume of the second node has transgressed a threshold.

14. A memory-reclaiming system comprising:
a processor;
a memory in communication with the processor, the memory being configured to store a memory-reclaiming module that is executable by the processor, the memory-reclaiming module having instructions that, when executed by the processor, cause the processor to perform operations comprising:
receiving, at a second node of the memory-reclaiming system, a snapshot name prefix about a snapshot transmitted from a first node of the memory-reclaiming system, the snapshot name prefix being stored as an entry in a table that is stored in a non-volatile memory of the second node, the entry identifying the snapshot name prefix as corresponding to a scheduled snapshot or a user snapshot;
in response to the second node receiving the snapshot name prefix from the first node, synchronizing, at the second node, the snapshot name prefix in the non-volatile memory of the second node with a copy of the snapshot name prefix in a volatile memory of the second node, the volatile memory of the second node storing a plurality of copies of snapshot name prefixes corresponding to snapshots stored in the storage system;
accessing, at the second node, a policy that specifies whether the user snapshot is to be deleted before the scheduled snapshot;
accessing the volatile memory of the second node rather than the non-volatile memory of the second node to determine one or more snapshots to delete based on the policy and the plurality of copies of snapshot name prefixes; and
deleting the one or more snapshots.

15. The system of claim 14, wherein the instructions cause the processor to access the policy in response to detecting that a pre-defined condition has occurred.

16. The system of claim 14, wherein the volatile memory of the second node of the memory-reclaiming system is associated with a microkernel of the memory-reclaiming system and the non-volatile memory of the second node of the memory-reclaiming is associated with a management module of the memory-reclaiming system.

17. The system of claim 14, wherein the instructions cause the processor to delete the snapshot by sending a request from a main process executing on the second node to a worker process executing on the second node.

18-21. (canceled)

22. A non-transitory computer-readable medium storing instructions that, when executed by a processor, cause the processor to perform operations comprising:
receiving, at a second node of a storage system, a snapshot name prefix about a snapshot transmitted from a first node of the storage system, the snapshot name prefix being stored as an entry in a table that is stored in a non-volatile memory of the second node, the entry identifying the snapshot name prefix as corresponding to a scheduled snapshot or a user snapshot;
in response to the second node receiving the snapshot name prefix about the snapshot from the first node, synchronizing, at the second node, the snapshot name prefix in the non-volatile memory of the second node with a copy of the snapshot name prefix in a volatile memory of the second node, the volatile memory of the second node storing a plurality of copies of snapshot name prefixes corresponding to snapshots stored in the storage system;
accessing, at the second node, a policy that governs a deletion of snapshots stored in the storage system;
accessing the volatile memory of the second node rather than the non-volatile memory of the second node to determine one or more snapshots to delete based on the policy and the plurality of copies of snapshot name prefixes; and
deleting the one or more snapshots.

23. The non-transitory computer-readable medium of claim 22, wherein the policy specifies that a scheduled snapshot is to be deleted before a user snapshot.

24. The non-transitory computer-readable medium of claim 22, wherein the policy specifies that a user snapshot is to be deleted before a scheduled snapshot.

25. The non-transitory computer-readable medium of claim 22, wherein the policy is accessed in response to detecting that a pre-defined condition has occurred.

26. The non-transitory computer-readable medium of claim 22, wherein the snapshot name prefix corresponds to a first set of one or more characters of a name of the snapshot.

27. The non-transitory computer-readable medium of claim 26, wherein an indicator character distinguishes the snapshot name prefix from a remainder of the name of the snapshot.

28. The non-transitory computer-readable medium of claim 22, wherein the policy specifies an order in which snapshots is to be deleted based on age of the snapshots.
